(19) United States
(12) Patent Application Publication
(10) Pub. No.: US 2013/0015673 A1
(43) Pub. Date: Jan. 17, 2013

(54) VEHICLE DOOR LOCK DEVICE

(71) Applicants: Ryujiro Akizuki, Novi, MI (US); Takashi Nishio, Kariya-shi (JP); Nobuko Watanabe, Anjo-shi (JP); Yasuhiko Sono, Hekinan-shi (JP); Kazunori Kojima, Aichi-gun (JP)

(72) Inventors: Ryujiro Akizuki, Novi, MI (US); Takashi Nishio, Kariya-shi (JP); Nobuko Watanabe, Anjo-shi (JP); Yasuhiko Sono, Hekinan-shi (JP); Kazunori Kojima, Aichi-gun (JP)

(73) Assignee: ASIN SEIKI KABUSHIKI KAISHA, Kariya-shi (JP)

(21) Appl. No.: 13/637,183

(22) PCT Filed: Mar. 10, 2011
(86) PCT No.: PCT/JP2011/055632

§ 371 Date: Sep. 25, 2012

(30) Foreign Application Priority Data
Apr. 22, 2010 (JP) 2010098734

(51) Int. Cl. E05B 65/20

(52) U.S. Cl. 292/307 R

(57) ABSTRACT

A vehicle door lock device includes a latch mechanism, a lever mechanism, a link mechanism, and an electric actuator, assembled to a housing. The housing includes a housing body and a housing cover joined to each other, and is arranged so that a joining surface between the housing body and the housing cover extends along an up-and-down direction. A sealing portion is formed along a joining portion between the housing body and the housing cover to surround an upper part of an inner space of the housing accommodating the link mechanism and the electric actuator. The sealing portion includes a communication path including one open end, and inner and outer welded portions formed continuously along the communication path on an inner side of the housing and an outer side of the housing with respect to the communication path, respectively. This achieves waterproofing for the electric actuator.

### TECHNICAL FIELD

The present invention relates to a vehicle door lock device.

### BACKGROUND ART

As one of vehicle door lock devices, there is known a vehicle door lock device including: a latch mechanism, which is capable of keeping a door of a vehicle closed with respect to a body, and is assembled to the door together with a housing; a lever mechanism, which is assembled to the housing, and is driven through operation of a door handle provided to the door; a link mechanism, which is interposed in the housing between the latch mechanism and the lever mechanism, and is capable of being switched between an unlock state in which transmission of an operating force from the lever mechanism to the latch mechanism is enabled, and a lock state in which the transmission of the operating force is disabled; and an electric actuator (electrical part), which is assembled into the housing, and switches the link mechanism between the unlock state and the lock state. This vehicle door lock device is disclosed in, for example, Patent Document 1 below.

### PRIOR ART DOCUMENT

### Patent Document

Patent Document 1: JP 2006-233506 A

In the vehicle door lock device described in the above-mentioned Patent Document 1, waterproofing measures for the above-mentioned electric actuator (electrical part) are taken for the housing. The waterproofing measures described in the above-mentioned Patent Document 1 are taken in such a manner that a waterproof cover is disposed over the housing, and a water passage hole is formed in an upper portion of the housing, for preventing water from entering an accommodating space of the housing in which the electric actuator (electrical part) is accommodated.

### SUMMARY OF THE INVENTION

### Technical Problem

By the way, the vehicle door lock device described in the above-mentioned Patent Document 1 requires the waterproof cover, and hence the number of parts is increased. Further, the water passage hole formed in the upper portion of the housing can be expected to exert a desired function and provide desired waterproofing effects, but it is not assured that all of water, which falls to the upper portion of the housing and adheres thereto, flows into the water passage hole. Therefore, there is a fear in that water enters the accommodating space of the housing in which the electric actuator (electrical part) is accommodated.

### Solution to Problem

The present invention has been made to solve the above-mentioned problem, and therefore provides a vehicle door lock device, including: a latch mechanism, which is capable of keeping a door of a vehicle closed with respect to a body, and is adapted to be assembled to the door together with a housing; a lever mechanism, which is adapted to be assembled to the housing, and to be driven through operation of a door handle provided to the door; a link mechanism, which is interposed in the housing between the latch mechanism and the lever mechanism, and is capable of being switched between an unlock state in which transmission of an operating force from the lever mechanism to the latch mechanism is enabled, and a lock state in which the transmission of the operating force is disabled; and an electric actuator, which is assembled into the housing, and switches the link mechanism between the unlock state and the lock state; in which the housing includes a housing body and a housing cover joined to each other, and is arranged so that a joining surface between the housing body and the housing cover extends along an up-and-down direction, in which a sealing portion is formed along a joining portion between the housing body and the housing cover so as to surround an upper part of an inner space of the housing accommodating the link mechanism and the electric actuator, and in which the sealing portion includes: a communication path, which is formed along the joining portion, and includes at least one open end; and an inner welded portion and an outer welded portion, which are formed continuously along the communication path on an inner side of the housing and an outer side of the housing with respect to the communication path, respectively.

In this case, the communication path may include: a communication groove formed in one of the housing body and the housing cover; and an end wall formed in another one of the housing body and the housing cover so as to close the communication groove. Further, the inner welded portion and the outer welded portion may be formed by laser welding. For example, the housing body may be made of a laser-beam-nontransmissive resin material, and the housing cover may be made of a laser-beam-transmissive resin material. Therefore, the inner welded portion and the outer welded portion may be subjected to the laser welding through irradiation of a laser beam from the housing cover side. Further, the communication path may include one open end and another closed end, and the inner welded portion and the outer welded portion may be connected to each other at the another closed end. Further, the communication path may include both ends that are open downward.

### Advantageous Effects of Invention

According to the vehicle door lock device of the present invention, the sealing portion formed along the joining portion between the housing body and the housing cover is configured as described above, and hence the above-mentioned sealing portion prevents water, which falls from above to an upper portion of the housing and adheres thereto, from entering the inner space of the housing accommodating the link mechanism and the electric actuator. Therefore, according to the present invention, without use of a waterproof cover, the link mechanism and the electric actuator can be protected from the water with a simple and inexpensive configuration.

Further, according to the present invention, in the above-mentioned sealing portion, the inner welded portion and the outer welded portion are formed continuously along the communication path, and hence the communication path except both ends thereof is sealed by the inner welded portion and the outer welded portion. Accordingly, pressurized gas (for example, compressed air) is charged into the communication path, and the gas pressure is examined. In this way, it is possible to easily determine whether or not the above-mentioned sealing portion maintains satisfactory sealing properties (airtightness and fluid-tightness).

When carrying out the present invention described above, in the case where the communication path includes the communication groove formed in one of the housing body and the housing cover, and the end wall formed in another one of the housing body and the housing cover so as to close the communication groove, the communication path can be formed simply at low cost. Further, in the case where the inner welded portion and the outer welded portion are formed by laser welding, in comparison to a case where the inner welded portion and the outer welded portion are formed by vibration welding, it is possible to suppress influence on components accommodated in the housing.

Further, when carrying out the present invention described above, in the case where the communication path includes one open end and another closed end, and the inner welded portion and the outer welded portion are connected to each other at the closed end, it is possible to charge pressurized gas (for example, compressed air) into the communication path from the open end portion of the communication path, and through connecting a connection tool capable of examining the gas pressure to the open end portion of the communication path, it is possible to easily determine whether or not the above-mentioned sealing portion maintains satisfactory sealing properties (airtightness and fluid-tightness).

Still further, when carrying out the present invention described above, in the case where the communication path includes both ends that are open downward, even if water flows through the outer welded portion toward the housing, the water is trapped in the communication path and is prevented from entering the upper part of the inner space of the housing. Further, the water trapped in the communication path drips down from the end portion of the communication path, and hence does not enter the upper part of the inner space of the housing. Therefore, water falling from above can be appropriately prevented from entering the upper part of the inner space of the housing.

### BRIEF DESCRIPTION OF THE DRAWINGS

FIG. 1 is a side view seen from an inner side of a vehicle, for illustrating a vehicle door lock device according to an embodiment of the present invention.

FIG. 2 is a view for illustrating a state in which operation cables and a housing cover are removed from the vehicle door lock device of FIG. 1.

FIG. 3 is a sectional view taken along the line A-A of FIG. 2.

FIG. 4 is a sectional view taken along the line B-B of FIG. 2.

FIG. 5 is an enlarged view for illustrating a sealing portion of FIG. 4.

### MODE FOR CARRYING OUT THE INVENTION

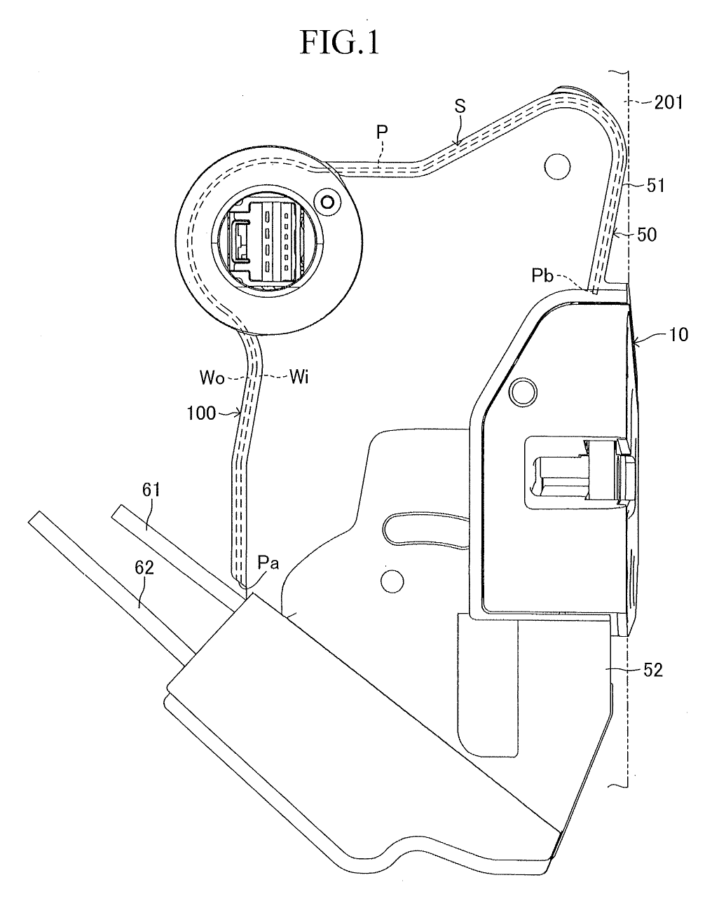

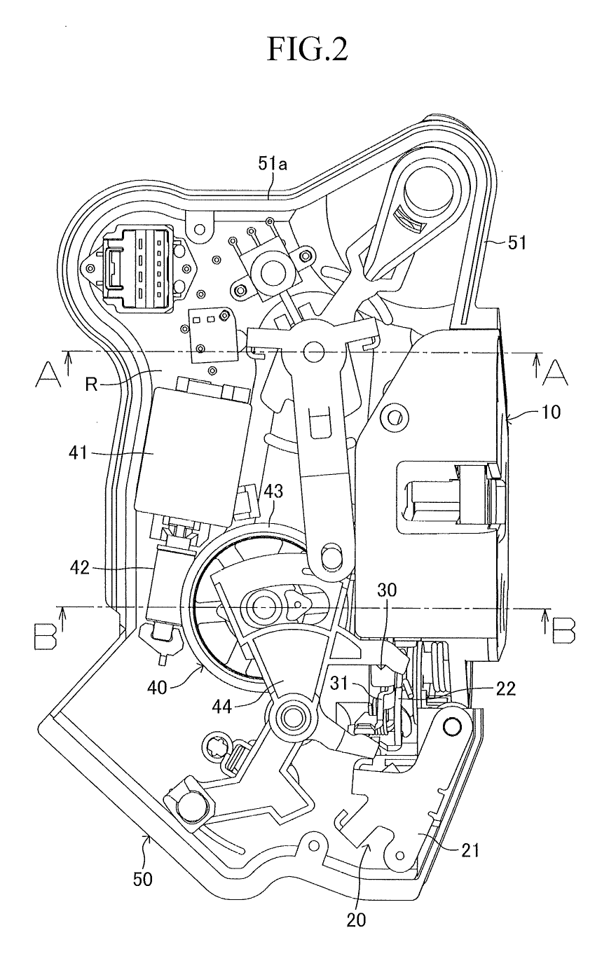

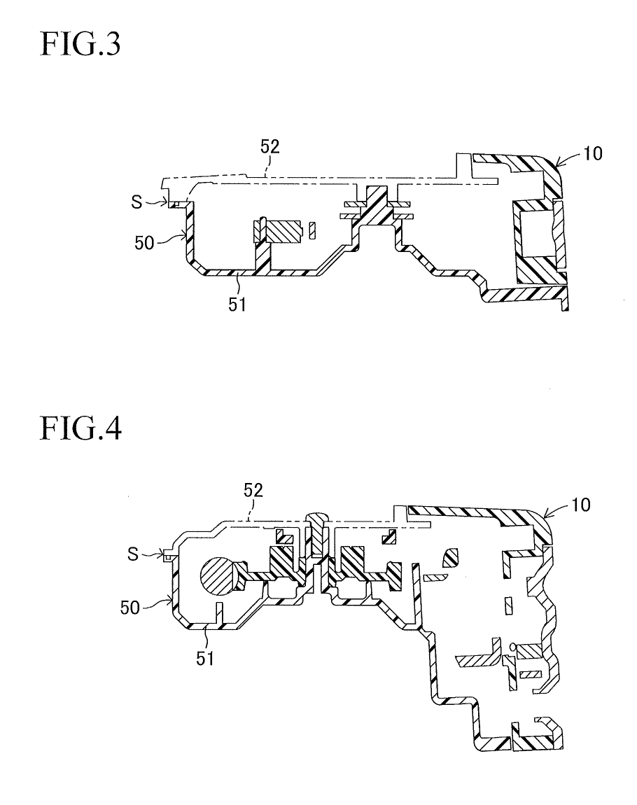

In the following, an embodiment of the present invention is described with reference to the drawings. FIGS. 1 to 5 illustrate a vehicle door lock device 100 according to the present invention. The vehicle door lock device 100 is installed in a door 201 mounted on a front right side of a vehicle. The vehicle door lock device 100 includes a latch mechanism 10, a lever mechanism 20, a link mechanism 30, and an electric actuator 40, which are assembled to a housing 50.

As is well known, the latch mechanism 10 keeps the door 201 of the vehicle closed with respect to a body (vehicle body (not shown)) (keeps a state in which the door 201 is closed), and includes a latch 11 which is engageable with and disengageable from a striker (not shown) fixed to the body. The latch mechanism 10 is assembled to the door 201 under a state in which the latch mechanism 10 is assembled to the housing 50.

The lever mechanism 20 includes an inside open lever 21 which is driven in accordance with operation of an inside door handle (not shown) provided on an inner side of the door 201, and an outside open lever 22 which is driven in accordance with operation of an outside door handle (not shown) provided on an outer side of the door 201. The inside open lever 21 is assembled to the housing 50, and is linked with the inside door handle through the intermediation of an operation cable 61 illustrated in FIG. 1 (operating force transmitting member such as a link may be used instead). Thus, the inside open lever 21 is driven through the operation of the inside door handle. The outside open lever 22 is assembled to the housing 50, and is linked with the outside door handle through the intermediation of an operating force transmitting member (not shown) such as a link. Thus, the outside open lever 22 is driven through the operation of the inside door handle.

The link mechanism 30 is interposed in the housing 50 between the latch mechanism 10 and the lever mechanism 20, and includes an open link 31 which can be switched between an unlock state in which transmission of an operating force from the lever mechanism 20 to the latch mechanism 10 is enabled, and a lock state in which the transmission of the operating force is disabled. The open link 31 is interposed between the inside open lever 21 provided to the lever mechanism 20 and a lift lever (not shown) provided to the latch mechanism 10, and between the outside open lever 22 provided to the lever mechanism 20 and the lift lever. The open link 31 can be switched between an unlock position at which an action of each open lever 21, 22 in a door opening direction is transmitted to the lift lever (the transmission of the operating force is enabled), and a lock position at which the action of each open lever 21, 22 is not transmitted to the lift lever (the transmission of the operating force is disabled), the action of each open lever 21, 22 being accompanied when each door handle is operated to open the door.

The electric actuator 40 is assembled into the housing 50, and can switch the link mechanism 30 between the unlock state and the lock state. The electric actuator 40 includes an electric motor 41, a worm 42, and a worm wheel 43, and further includes an active lever 44 which is driven by those components. Note that, the active lever 44 is coupled through the intermediation of an operation cable 62 illustrated in FIG. 1 to a lock knob (not shown) provided to the door 201 on an inner side of the vehicle, and can be driven also through manual operation of the lock knob (not shown). Further, the active lever 44 is coupled also to a key cylinder (not shown) provided on the outer side of the door 201, and can be driven also through manual operation of the key cylinder (not shown).

By the way, in this embodiment, the housing 50 includes a housing body 51 and a housing cover 52 joined to each other, and is arranged so that a joining surface between the housing body 51 and the housing cover 52 extends along an up-and-down direction. Along a joining portion between the housing body 51 and the housing cover 52, a sealing portion S is formed so as to surround an upper part of an inner space R of the housing accommodating the link mechanism 30 and the electric actuator 40.

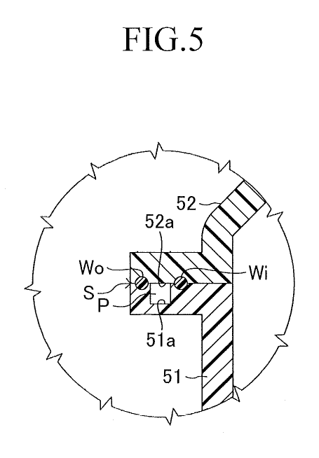

In the sealing portion S, there is formed a communication path P (see broken lines of FIG. 1) which is formed along the joining portion, and includes one open end Pa and another closed end Pb. Further, as illustrated exaggeratedly in FIG. 5, on an inner side of the housing and an outer side of the housing with respect to the communication path P, an inner welded portion Wi and an outer welded portion Wo are formed continuously along the communication path P, respectively.

As illustrated in FIG. 5, the communication path P includes a communication groove 51a formed in the housing body 51 to have a rectangular cross-section, and an end wall 52a formed in the housing cover 52 so as to close the communication groove 51a. Note that, the communication path (P) may include a communication groove formed in the housing cover (52), and an end wall formed in the housing body (51) so as to close the communication groove.

The inner welded portion Wi and the outer welded portion Wo are formed by laser welding. Further, the inner welded portion Wi and the outer welded portion Wo are connected to each other at the closed end Pb of the communication path P, and seal a periphery of the communication path P except the open end Pa of the communication path P airtightly and fluid-tightly. Further, in this embodiment, the housing body 51 is made of a laser-beam-nontransmissive resin material, whereas the housing cover 52 is made of a laser-beam-transmissive resin material. A laser beam having a light intensity necessary for desired laser welding is irradiated from the housing cover 52 side.

In the vehicle door lock device 100 according to this embodiment configured as described above, the sealing portion S formed along the joining portion between the housing body 51 and the housing cover 52 is configured as described above, and hence the above-mentioned sealing portion S prevents water, which falls from above to an upper portion of the housing 50 and adheres thereto, from entering the inner space R of the housing accommodating the link mechanism 30 and the electric actuator 40. Therefore, in this embodiment, without use of a waterproof cover, the link mechanism 30 and the electric actuator 40 can be protected from the water with a simple and inexpensive configuration.

Further, in this embodiment, in the above-mentioned sealing portion S, the inner welded portion Wi and the outer welded portion Wo are formed continuously along the communication path P, and are connected to each other at the closed end Pb of the communication path P. Thus, the communication path P except the open end Pa is sealed by the inner welded portion Wi and the outer welded portion Wo airtightly and fluid-tightly. Accordingly, it is possible to charge pressurized gas (for example, compressed air) into the communication path P from the open end portion of the communication path P, and through connecting a connection tool (not shown) capable of examining the gas pressure to the open end portion of the communication path P, it is possible to easily determine whether or not the above-mentioned sealing portion S maintains satisfactory sealing properties (airtightness and fluid-tightness).

Further, in this embodiment, the communication path P includes the communication groove 51a formed in the housing body 51, and the end wall 52a formed in the housing cover 52 so as to close the communication groove 51a, and hence the communication path S can be formed simply at low cost. Further, the inner welded portion Wi and the outer welded portion Wo are formed by laser welding, and hence in comparison to a case where the inner welded portion Wi and the outer welded portion Wo are formed by vibration welding, it is possible to suppress influence on components accommodated in the housing 50.

In the above-mentioned embodiment, the present invention is carried out in such a manner that the communication path P is shaped to include the one open end Pa and the another closed end Pb, but may be carried out in such a manner that the communication path (P) is shaped to include both ends that are open downward. In this case, even if water flows through the outer welded portion (Wo) toward the housing (50), the water is trapped in the communication path (P) and is prevented from entering the upper part of the inner space (R) of the housing. Further, the water trapped in the communication path (P) drips down from the end portion of the communication path (P), and hence does not enter the upper part of the inner space (R) of the housing. Therefore, water falling from above can be appropriately prevented from entering the upper part of the inner space (R) of the housing.

1. A vehicle door lock device, comprising:
a latch mechanism, which is capable of keeping a door of a vehicle closed with respect to a body, and is adapted to be assembled to the door together with a housing;
a lever mechanism, which is adapted to be assembled to the housing, and to be driven through operation of a door handle provided to the door;
a link mechanism, which is interposed in the housing between the latch mechanism and the lever mechanism, and is capable of being switched between an unlock state in which transmission of an operating force from the lever mechanism to the latch mechanism is enabled, and a lock state in which the transmission of the operating force is disabled; and
an electric actuator, which is assembled into the housing, and switches the link mechanism between the unlock state and the lock state;
wherein the housing comprises a housing body and a housing cover joined to each other, and is arranged so that a joining surface between the housing body and the housing cover extends along an up-and-down direction,
wherein a sealing portion is formed along a joining portion between the housing body and the housing cover so as to surround an upper part of an inner space of the housing accommodating the link mechanism and the electric actuator, and
wherein the sealing portion comprises:
a communication path, which is formed along the joining portion, and comprises at least one open end; and
an inner welded portion and an outer welded portion, which are formed continuously along the communication path on an inner side of the housing and an outer side of the housing with respect to the communication path, respectively.

2. A vehicle door lock device according to claim 1, wherein the communication path comprises:
a communication groove formed in one of the housing body and the housing cover; and
an end wall formed in another one of the housing body and the housing cover so as to close the communication groove.

3. A vehicle door lock device according to claim 1, wherein the inner welded portion and the outer welded portion are formed by laser welding.

4. A vehicle door lock device according to claim 3,
wherein the housing body is made of a laser-beam-nontransmissive resin material,
wherein the housing cover is made of a laser-beam-transmissive resin material, and
wherein the inner welded portion and the outer welded portion are subjected to the laser welding through irradiation of a laser beam from the housing cover side.

5. A vehicle door lock device according to claim 1,
wherein the communication path comprises one open end and another closed end, and
wherein the inner welded portion and the outer welded portion are connected to each other at the another closed end.

6. A vehicle door lock device according to claim 1, wherein the communication path comprises both ends that are open downward.
